(19) United States
(12) Patent Application Publication
(10) Pub. No.: US 2023/0187649 A1
(43) Pub. Date: Jun. 15, 2023

(54) Lithium Ion Battery and Method for Manufacturing Such a Lithium Ion Battery

(71) Applicant: Bayerische Motoren Werke Aktiengesellschaft, Muenchen (DE)

(72) Inventors: Roland JUNG, Muenchen (DE); Thomas WOEHRLE, Muenchen (DE)

(21) Appl. No.: 17/925,459

(22) PCT Filed: Jun. 23, 2021
(86) PCT No.: PCT/EP2021/067052

§ 371 Date: Nov. 15, 2022

(30) Foreign Application Priority Data
Jul. 9, 2020 (DE) 10 2020 118 129.9

(51) Int. Cl. H01M 4/62; H01M 10/0525; H01M 4/36; H01M 4/131; H01M 4/525; H01M 4/505; H01M 10/058

(52) U.S. Cl. CPC H01M 4/628; H01M 10/0525; H01M 4/364; H01M 4/131; H01M 4/525; H01M 4/505; H01M 10/058; H01M 2004/021

(57) ABSTRACT

A lithium ion battery includes a cathode having a composite cathode active material, and an anode having an anode active material, where the composite cathode active material has at least a first and a second cathode active material. The first and the second cathode active materials each are selected from the group consisting of layered oxides, compounds having an olivine structure, compounds having a spinel structure, and combinations thereof. The first cathode active material has a degree of lithiation a and the second cathode active material has a degree of lithiation b, where a<1, b<1, and |a−b|<0.1 before a first discharging process and/or charging process of the lithium ion battery. The anode active material is pre-lithiated before the first discharging process and/or charging process of the lithium ion battery. A method for manufacturing is also described.

### BACKGROUND AND SUMMARY

The invention relates to a lithium ion battery and to a method for producing such a lithium battery.

Below, the term “lithium ion battery” is used synonymously for all customary prior-art designations for lithium-containing galvanic elements and cells, such as, for example, lithium battery cell, lithium battery, lithium ion battery cell, lithium cell, lithium ion cell, lithium polymer cell, lithium polymer battery, and lithium ion accumulator. The term includes, in particular, rechargeable batteries (secondary batteries). The terms “battery” and “electrochemical cell” are also utilized synonymously with the term “lithium ion battery” and “lithium ion battery cell”. The lithium ion battery may also be a solid-state battery, such as a ceramic or polymer-based solid-state battery.

A lithium ion battery has at least two different electrodes: a positive (cathode) and a negative (anode) electrode. Each of these electrodes comprises at least one active material, optionally together with additives such as electrode binders and electrical conductivity additives.

A general description relating to the lithium ion technology is found in chapter 9 (Lithium-ion cell, author: Thomas Wohrle) of the “Handbuch Lithium-Ionen-Batterien” (editor: Reiner Korthauer, Springer, 2013) and also in chapter 9 (Lithium-ion cell, author: Thomas Wohrle) of the book “Lithium-Ion Batteries: Basics and Applications” (editor: Reiner Korthauer, Springer, 2018). Suitable cathode active materials are known from EP 0 017 400 B1 and also DE 3319939 A1. A compilation of relevant data on cathode active materials is found in D. Andre et al., “Future generations of cathode materials: an automotive industry perspective,” J. Mater. Chem. A., DOI: 10.1039/c5ta00361j.

In lithium ion batteries, both the cathode active material and the anode active material must be capable of reversibly receiving and releasing lithium ions. According to the prior art, lithium ion batteries are generally assembled and processed in the fully uncharged state. This corresponds to a state in which the lithium ions are fully intercalated, i.e., incorporated, in the cathode, while the anode typically has no active lithium ions, these being ions amenable to reversible cycling.

In the first charging of the lithium ion battery, also known by the term “formation,” the lithium ions depart the cathode and are intercalated in the anode. This first charging entails complex events with a multiplicity of reactions occurring between the various components of the lithium ion battery.

Of particular significance in this context is the formation of an interface, also referred to as “solid electrolyte interface” or “SEI,” between active material and electrolyte on the anode. The formation of the SEI, which is also regarded as a protective layer, is attributed substantially to decomposition reactions of the electrolyte (dissolved conductive lithium salt in organic solvents) with the surface of the anode active material.

Construction of the SEI, however, requires lithium, which is subsequently no longer available for cycling in the charging and discharging process. The difference between the capacity after the first charging and the capacity after the first discharging, in relation to the charging capacity, is referred to as the formation loss and, depending on the cathode and anode active materials used, may lie within the range from about 5% to 40%.

The cathode active material may therefore be overdimensioned, in other words provided in a larger quantity, in order to achieve a desired nominal capacity of the completed lithium ion battery even after the formation loss, and this raises the costs in production and lowers the specific energy of the battery. As a consequence, there may also be increased demand for toxic metals and/or metals of limited availability that are needed for the production of the cathode active material, examples being cobalt and nickel.

From EP 3 255 714 B1 is known a practice to provide an additional lithium depot composed of a lithium alloy in the cell, in order to be able to compensate lithium losses during the formation of the cell and/or in the operation of the cell. The provision of additional components, however, implies a more complex cell construction, additional production processes with partly increased complexity, and higher costs.

For cell manufacture as known in the prior art, the lithium ion batteries are initially assembled in the uncharged state and then undergo formation. Formation is a most expensive process, requiring not only specific equipment but also compliance with exacting safety standards, particularly with regard to fire protection. Formation, however, is necessary in order to provide the lithium ion battery in ready-to-use form.

It is an object to provide a lithium ion battery which has a high specific energy and high current-carrying capacity and which is ready for deployment as an energy source even immediately after its production. A further intention is to specify a simple and inexpensive method for producing such a lithium ion battery.

These objects may be achieved by a lithium ion battery and a method for its production according to the independent claims of the patent. Advantageous refinements and developments of the invention are subjects of the dependent claims.

According to one embodiment, the lithium ion battery comprises a cathode, which comprises a composite cathode active material (that is, a composite positive active material), and an anode, which comprises at least one anode active material. The composite cathode active material comprises at least one first and one second cathode active material. The composite cathode active material may more particularly comprise not only particles of the first cathode active material but also particles of the second cathode active material. The first and second cathode active materials are each selected from a group consisting of layered oxides, including over-lithiated layered oxides (OLO), compounds with olivine structure, compounds with spinel structure, and combinations thereof.

The first cathode active material has a degree a of lithiation and the second cathode active material has a degree b of lithiation. The term “degree of lithiation” here and hereinafter denotes the amount of reversibly cyclable lithium, in the form of lithium ions and/or metallic lithium, in relation to the maximum amount of reversibly cyclable lithium in the active material. The degree of lithiation, in other words, is a measure of the fraction of the maximally cyclable lithium content that is incorporated or intercalated within the structure of the active material. A degree of lithiation of 1 here denotes a completely lithiated active material, whereas a degree of lithiation of 0 indicates a completely delithiated active material. For example, in a stoichiometric olivine LiFePO₄, the degree of lithiation is 1, and for pure FePO₄ it is, correspondingly, 0.

Because, after the filling with electrolyte and more particularly during the first discharging and/or charging, depending on the particular voltage windows of the cathode active materials, the lithium ions may not be intercalated evenly into the cathode materials, the ratio of the degrees of lithiation of the first and second cathode active materials after the filling with electrolyte and/or after the first discharging and/or charging may differ from the initial state in the composite cathode active material. The data regarding the degrees of lithiation of the first and second cathode active materials in the composite cathode active material of the invention may therefore be based on the state before the first discharging and/or charging and more particularly before the filling of the lithium ion battery with electrolyte.

The degrees a and b of lithiation of the cathode active materials before the filling of the lithium ion battery with electrolyte and hence before the first discharging and/or charging of the lithium ion battery are less than 1. Additionally, the difference in the degrees a and b of lithiation is less than 0.1. It is therefore the case that a<1, b<1 and |a−b|<0.1.

Before the first discharging and/or charging of the lithium ion battery, the anode active material is prelithiated. The term “prelithiated” or “prelithiation” indicates that in the anode active material lithium is present, more particularly intercalated and/or alloyed, in the structure of the anode active material even before the first discharging and/or charging, in particular, before the filling with electrolyte. The negative active material is therefore already loaded with lithium.

The lithium used for prelithiation is able not only to be later available as a lithium reserve in the charging and discharging cycles of the lithium ion battery but also to be utilized for the formation of an SEI even before, or during, the first discharging and/or charging of the lithium ion battery. The prelithiation is therefore able at least partly to compensate the formation losses that otherwise occur. This enables a further reduction in the quantity of the cathode active materials and, in association with this, a further reduction in the quantity of the expensive and possibly toxic metals, for example, cobalt and nickel. Furthermore, the reactions for forming the SEI need not take place only during the first discharging and/or charging of the assembled lithium ion battery, but may instead be carried out at least partly during the actual production of the anode active material and/or anode, more particularly, after the introduction of the electrolyte filling.

In particular, the anode material is prelithiated to an extent such that there is more lithium present than is needed for forming the SEI during anode production and/or during formation of the lithium ion battery. The anode active material before the first discharging and/or charging of the lithium ion battery, more particularly before the filling with electrolyte, may have a degree c. of lithiation of more than 0 and, additionally, may have a stable SEI. The anode active material may in particular have substoichiometric prelithiation, meaning that the degree c. of lithiation of the active material is below 1. The degree c. of lithiation of the anode active material may more particularly be in the range from 0.01 to 0.5, preferably in the range from 0.05 to 0.30. If using graphite as anode active material, this would correspond to a composition of Li_{0.01≤x≤0.5}C₆ or Li_{0.05≤x≤0.30}C₆, respectively. If using silicon as anode active material, it would correspond to a composition of Li_{0.0375≤x≤1.875}Si₁ or Li_{0.1875≤x≤1.125}Si₁, respectively. Alternatively, the anode active material may also have full prelithiation (c=1). Correspondingly, LiC₆ or Li_{3.75}Si, respectively. Through the prelithiation of the anode, the irreversible capacity of the lithium ion battery in the first cycle can be lowered down to 0.

The technology rests in particular on the considerations set out below: Through the combination of an at least partly delithiated composite cathode active material and of an—optionally substoichiometrically—prelithiated anode active material, the lithium ion battery directly after assembly is already at least partly charged and therefore suitable immediately for use. The first discharging and/or charging may take place, correspondingly, directly in the intended application, with the end customer, for example. Individual electrochemical cells may also first be connected to form a battery module and only then discharged and/or charged for the first time. In this way, there is no need for the precharge step and the formation step, i.e., the first-time charging of the lithium ion battery, during the production process, and the production time is shortened as a result. There are also reductions in the power consumption for production and in the extent, capital costs and operation of the required production plants.

Partly or fully delithiated cathode active materials are available commercially or may be obtained by electrochemical extraction of lithium from fully or partly lithiated cathode active materials. Also possible is a chemical extraction of lithium from fully or partly lithiated cathode active materials wherein the lithium is leached out by means of acids, such as by means of sulfuric acid (H₂SO₄), for example.

The degree of lithiation of the composite cathode active material may be adapted in particular to the prelithiation of the anode active material. In other words, the degree of lithiation of the composite cathode active material may be lowered by the quantity of lithium utilized for the prelithiation—including SEI formation—of the anode active material. In this way, the specific energy and/or energy density, or the open cell voltage, of the lithium ion battery may be further optimized.

In one preferred embodiment, the degrees of lithiation of the first and second cathode active materials are such that 0.5≤a≤0.9 and/or 0.5≤b≤0.9, more preferably 0.6≤a≤0.8 and/or 0.6≤b≤0.8.

According to one embodiment, the first cathode active material and the second cathode active material have a different crystal structure. On the basis of their different crystal structure, the cathode active materials may have different properties in relation in particular to kinetics, performance, thermal, chemical and electrochemical stability, specific capacity, energy density, etc. The use of a first and a second cathode active material having different crystal structures makes it possible advantageously to combine the various properties of the materials in a targeted way, in order thereby to achieve targeted and tailored provision and optimization of the properties of the lithium ion battery for its respective field of use.

According to one preferred embodiment, the first cathode active material is a compound with spinel structure and the second cathode active material is a compound with olivine structure. Olivine compounds and spinel compounds exhibit rapid and reversible kinetics for the intercalation of lithium ions, so resulting in a high current-carrying capacity and an advantageous low-temperature behavior of the lithium ion battery. Furthermore, compounds with olivine and spinel structures are very stable chemically, thermally and electrochemically, providing the lithium ion battery with a high intrinsic safety. Moreover, such compounds are entirely compatible with common electrode binders, electrolyte compositions, and conductivity additives, for example, conductive carbon black, and also with the common production processes for cathode active materials, examples including metering, mixing, coating, drying, calendering, punching, cutting, winding, stacking, and laminating processes.

Partly or fully delithiated, spinel- and olivine-based cathode active materials are available commercially or may be obtained by electrochemical extraction of lithium from fully or partly lithiated cathode active materials. Also possible is a chemical extraction of lithium from fully or partly lithiated cathode active materials wherein the lithium is leached out by means of acids, such as by means of sulfuric acid (H₂SO₄), for example.

The spinel compound of the first cathode material may comprise, for example, λ-Mn₂O₄. The spinel compound of the first cathode active material may also contain further metals, such as nickel, in any desired stoichiometry (e.g., Ni_{0.5}Mn_{1.5}O₄, a delithiated form of what is called high-voltage spinel). Preferably, the spinel compound contains manganese, preferably exclusively manganese, and no further toxic metals and/or metals that are not very readily available.

The olivine compound of the second cathode material may comprise, for example, FePO₄. The olivine compound may contain further metals in any desired stoichiometry, such as manganese, nickel and/or cobalt (e.g., Fe_{0.5}Mn_{0.5}PO₄, NiPO₄, CoPO₄, Fe_{0.5}Co_{0.5}PO₄, etc.). The olivine compound in the delithiated state preferably contains exclusively iron and/or manganese and no further toxic metals and/or metals that are not very readily available, as may be the case in particular for layered oxides.

The olivine compound can be used in a particle size in the 0.05 μm to 30 μm range, more particularly from 0.1 μm to 15 μm, preferably from 0.2 μm to 5 μm, more preferably from 0.2 μm to 1 μm. The spinel compound can be used in a particle size in the 0.5 μm to 35 μm range, preferably from more than 1 μm to 20 μm, more preferably from 4 μm to 20 μm. Such particle sizes are ideally suitable for blending of the compounds with further particles. Moreover, the cathode active material may also be used as a single crystal, in order in particular to maximize the electrode density. They are also suitable for blending with other classes of compound as well, especially layered oxides such as lithium-nickel-manganese-cobalt oxide (NMC), lithium-nickel-cobalt-aluminum oxide (NCA), and lithium-cobalt oxide (LCO), for example, or else over-lithiated layered oxides (OLOs). In this way, a homogeneous and highly compacted composite cathode electrode can be obtained. The weight fractions of the cathode active materials may in principle be selected arbitrarily, according to the requirement of the lithium ion battery.

In one preferred refinement, the particles of the first cathode active material have on average a larger diameter than the particles of the second cathode active material. The differing size of the particles makes it possible in particular to achieve a high packing density of the cathode active materials in the cathode. Preferably, particles of the first cathode active material have on average a diameter d₁>1 μm and the particles of the second cathode active material have on average a diameter d₂≤1 μm.

The anode active material may be selected from the group consisting of carbon-containing materials, silicon, silicon suboxide, silicon alloys, aluminum alloys, indium, indium alloys, tin, tin alloys, cobalt alloys, and mixtures thereof. The anode active material is preferably selected from the group consisting of synthetic graphite, natural graphite, graphene, mesocarbon, doped carbon, hard carbon, soft carbon, fullerene, silicon-carbon composite, silicon, surface-coated silicon, silicon suboxide, silicon alloys, lithium, aluminum alloys, indium, tin alloys, cobalt alloys, and mixtures thereof. Also suitable in principle are further anode active materials known per se from the prior art, examples including niobium pentoxide, titanium dioxide, titanates such as lithium titanate (Li₄Ti₅O₁₂), tin dioxide, lithium, lithium alloys and/or mixtures thereof.

Where the anode active material already contains lithium which takes no part in the cycling, such as lithium titanate (Li₄Ti₅O₁₂), for example, i.e., which is not active lithium, then this fraction of lithium is considered in accordance with the invention not to be part of the prelithiation. In other words, this fraction of lithium has no influence on the degree b of lithiation of the second active material. In addition to the anode active material, the anode may comprise further components and additives, such as, for example, a film carrier, a binder or conductivity improvers. Further components and additives employed may be all customary materials and compounds known in the prior art.

According to one embodiment, the anode active material before the first discharging and/or charging of the lithium ion battery is prelithiated to an extent such that the lithium ion battery before the first discharging and/or charging has a state of charge (SoC)>0. The SoC indicates the capacity of the lithium ion battery that is still available, in relation to the maximum capacity of the lithium ion battery, and may be easily determined by way, for example, of the voltage and/or the current flow of the lithium ion battery.

The quantity of lithium which must be used for the prelithiation of the anode active material in order to achieve a particular SoC before the first discharging and/or charging of the lithium ion battery is dependent on whether an SEI is already formed on the anode active material before the first discharging and/or charging of the lithium ion battery. If this is the case, then the anode active material must be prelithiated to an extent such that the added lithium is sufficient both for forming the SEI and for achieving the corresponding capacity. The quantity of lithium needed for forming the SEI may be estimated on the basis of the anode active materials used.

The SoC of the lithium ion battery before the first discharging and/or charging, however, is dependent not only on the prelithiation of the anode active material, but also on the delithiation of the composite cathode active material. The anode active material can at least be prelithiated to an extent such as to compensate the missing lithium in the composite cathode active material. More particularly, the anode active material may also be prelithiated to an extent such as to result in a lithium excess in the lithium ion battery that is beneficial to the lifetime of the lithium ion battery.

In one variant, the anode active material before the first discharging and/or charging of the lithium ion battery is prelithiated to an extent such that the assembled lithium ion battery before the first discharging and/or charging has a state of charge (SoC) in the range from 1% to 30%, preferably from 3% to 25%, more preferably from 5% to 20%.

The lithium ion battery of the invention may be provided in particular in a motor vehicle or a portable device. The portable device may more particularly be a smartphone, an electrical tool or power tool, a tablet or a wearable.

The object of the invention may be further achieved by a method for producing a lithium ion battery, comprising steps as follows: First of all a composite cathode active material is provided by mixing at least a first cathode active material and a second cathode active material. The first and second cathode active materials are subject to the advantageous refinements described above. More particularly, the first and second cathode active materials are each selected from the group consisting of layered oxides, including over-lithiated layered oxides (OLOs), compounds with olivine structure, compounds with spinel structure, and combinations thereof, where the first cathode active material has a degree a of lithiation and the second cathode active material has a degree b of lithiation, and where before a first discharging and/or charging of the lithium ion battery, a<1, b<1 and |a−b|<0.1. Also provided is an anode active material. The composite cathode active material is subsequently installed in a cathode, and the anode active material in an anode, and a lithium ion battery is produced using the cathode and the anode. The anode active material is prelithiated before or after installation of the anode active material in an anode.

The individual constituents of the lithium ion battery are fabricated in particular from the materials described above. Accordingly, the above-described lithium ion battery is obtainable in particular by the method of the invention.

The anode active material may be prelithiated in particular by techniques known per se for producing lithium intercalation compounds or lithium alloys. For example, a mixture of the anode active material with metallic lithium may be produced. The mixture may subsequently be stored for a period of up to two weeks, preferably of up to one week, more preferably of up to five days. In this period, the metallic lithium is able to be intercalated into the anode active material, and so a prelithiated anode active material is obtained. In one variant, the prelithiation of the anode active material may be accomplished by combining the anode active material with a lithium precursor and subsequently reacting the lithium precursor to give lithium. In another variant, the prelithiation of the anode active material may be accomplished by injecting lithium into the anode active material and/or into the composite anode.

According to at least one embodiment, the anode is provided with an SEI before the production of the lithium ion battery. By storing the anode in an electrolyte, for example, over a predetermined period of 2 minutes to 14 days, for example, it is possible to construct a stable SEI on the anode. Lastly, it is possible to carry out the prelithiation of the anode active material by electrochemically treating the anode active material, installed to form an anode, in a lithium-containing electrolyte. In this way, the SEI can be formed on the anode during the prelithiation itself. Storage of the anode in the electrolyte allows the SEI to be further completed and stabilized.

Further advantages and properties of the invention are apparent from the following description of an exemplary embodiment in connection with FIG. 1.

### BRIEF DESCRIPTION OF THE DRAWINGS

FIG. 1 shows schematically the construction of a lithium ion battery according to one exemplary embodiment.

The constituents represented and also the size ratios of the constituents to one another should not be regarded as true to scale.

### DETAILED DESCRIPTION OF THE DRAWINGS

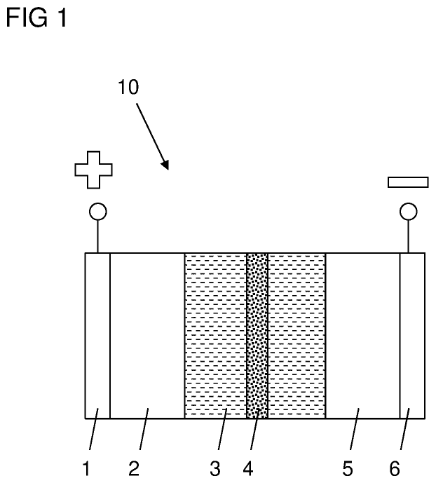

The lithium ion battery 10 represented purely schematically in FIG. 1 has a cathode 2 and an anode 5. The cathode 2 and the anode 5 each have a current collector 1, 6, and the current collectors 1, 6 may be implemented in the form of metal foils. The current collector 1 of the cathode may comprise aluminum, for example, and the current collector 6 of the anode may comprise copper.

The cathode 2 and the anode 5 are separated from one another by a separator 4 which is permeable to lithium ions but impermeable to electrons. Separators used may comprise a polymer, more particularly a polymer selected from the group consisting of polyesters, especially polyethylene terephthalate, polyolefins, especially polyethylene and/or polypropylene, polyacrylonitriles, polyvinylidene fluoride, polyvinylidene-hexafluoro-propylene, polyetherimide, polyimide, aramid, polyether, polyetherketone, synthetic spider silk or mixtures thereof. Additionally, the separator may optionally be coated with ceramic material and a binder, based for example on Al₂O₃.

The lithium ion battery, moreover, has an electrolyte 3 which is conducting for lithium ions and which may be either a solid-state electrolyte or a liquid which comprises a solvent and at least one conductive lithium salt dissolved therein, such as lithium hexafluoro-phoshate (LiPF₆), for example. The solvent is preferably inert. Examples of suitable solvents include organic solvents such as ethylene carbonate, propylene carbonate, butylene carbonate, dimethyl carbonate, diethyl carbonate, ethyl methyl carbonate, fluoroethylene carbonate (FEC), sulfolane, 2-methyltetrahydrofuan, acetonitrile, and 1,3-dioxolane. Solvents used may also be ionic liquids. Such ionic liquids contain exclusively ions. Preferred cations, which in particular may be alkylated, are imidazolium, pyridinium, pyrrolidinium, guanidinium, uronium, thiuronium, piperidinium, morpholinium, sulfonium, ammonium, and phosphonium cations. Examples of anions which can be used are halide, tetrafluoroborate, trifluoroacetate, triflate, hexafluorophosphate, phosphinate, and tosylate anions. Illustrative ionic liquids include N-methyl-N-propylpiperidinium bis(trifluoromethylsulfonyl)imide, N-methyl-N-butylpyrrolidinium bis(trifluoromethylsulfonyl)imide, N-butyl-N-trimethylammonium bis(tri-fluoromethylsulfonyl)imide, triethylsulfonium bis(trifluoromethylsulfonyl)imide, and N,N-diethyl-N-methyl-N-(2-methoxyethyl)ammonium bis(trifluoromethylsulfonyl)imide. In one variant, two or more of the above-stated liquids may be used. Preferred conductive salts are lithium salts which contain inert anions and which preferably are nontoxic. Suitable lithium salts are, in particular, lithium hexafluorophosphate (LiPF₆), lithium tetrafluoroborate (LiBF₄), and mixtures of these salts. The separator 4 may be impregnated or wetted with the lithium salt electrolyte if the latter is liquid.

In the lithium ion battery 10, the cathode 2 comprises a composite cathode active material which comprises at least one first and one second cathode active material. In particular, the composite cathode active material may comprise both particles of the first cathode active material and particles of the second cathode active material. The first and second cathode active materials are selected in each case from the group consisting of layered oxides, including over-lithiated layered oxides (OLOs), compounds with olivine structure, compounds with spinel structure, and combinations thereof.

The anode 5 comprises an anode active material which, even before the first discharging and/or charging of the lithium ion battery 10, is prelithiated.

The production of the lithium ion battery with the composite cathode active material and the prelithiated anode active material is elucidated below using a reference example, which may not have all of the features of the invention, and using an exemplary embodiment according to the invention.

Table 1 lists the substances and materials used in the examples.

TABLE 1
Substances and materials used

| | Description |
|---|---|
| LiₓMn₂O₄ (partly delithiated LiMn₂O₄) | Cathode active material |
| | (partly delithiated) |
| LiₓFePO₄ | Cathode active material |
| | (partly delithiated) |
| PVdF | Polyvinylidene fluoride, |
| | binder |
| NMP (electronic grade) | N-Methyl-2-pyrrolidone |
| | carrier solvent |
| Aluminum carrier foil | Carrier foil for cathode |
| Natural graphite | Anode active material |
| SBR | Styrene-butadiene rubber, |
| | binder |
| CMC | Carboxymethylcellulose, |
| | binder |
| Super C65 (conductive carbon black) | Conductivity additive |
| Copper carrier foil | Carrier foil for anode |
| Lithium | Prelithiating agent |
| Celgard Separator 2500 | Separator (25 μm) of |
| | polypropylene (PP) |
| Liquid electrolyte, comprising a solution of | Liquid electrolyte with |
| LiPF₆ in organic carbonates (e.g. ethylene | conductive lithium salt |
| carbonate (EC), diethylene carbonate (DEC)) | |
| Aluminum composite film | Packaging film for the cell |

### Example 1 (Reference Example)

A mixture of 47 wt % LiFePO₄, 47 wt % LiMn₂O₄, 3 wt % PVdF, and 3 wt % conductive carbon black is suspended in NMP at 20° C. using a dissolver mixer with high shear. A homogeneous coating material is obtained, which is knife-coated out onto an aluminum carrier foil 1 rolled to 15 μm. After the NMP has been stripped off, a composite cathode film is obtained with a surface weight of 29.8 mg/cm². In a similar way, an anode coating material having a composition of 94 wt % natural graphite, 2 wt % SBR, 2 wt % CMC, and 2 wt % Super C65 is produced and applied to a 10 μm rolled copper carrier foil 6. The anode film thus produced has a surface weight of 12.2 mg/cm².

The cathode 2 with the cathode film is installed, using an anode 5 with the anode film, a separator 4 (25 μm) made of polypropylene (PP), and a liquid electrolyte 3 of a 1 M solution of LiPF₆ in EC/DMC (3:7 w/w), to form an electrochemical cell with an active electrode area of 25 cm², and this cell is packaged into a highly finished composite aluminum foil (thickness: 0.12 mm) and sealed. The result is a pouch cell with external dimensions of about 0.5 mm×6.4 mm×4.3 mm.

The cell is charged for the first time to 4.2 V (C/10) and subsequently discharged to 2.8 V at C/10. The capacity of the first charge is 111 mAh and the capacity of the first discharge is 100 mAh. This results in a formation loss of around 10% for the complete cell. This corresponds to an anticipated formation loss of around 10% when using natural graphite as anode active material.

### Example 2 (Lithium Ion Battery of the Invention)

A mixture of 47 wt % Li_{0.8}FePO₄, 47 wt % Li_{0.8}Mn₂O₄, 3 wt % PVdF, and 3 wt % conductive carbon black is suspended in NMP at 20° C. using a dissolver mixer with high shear. A homogeneous coating material is obtained, which is knife-coated out onto an aluminum collector-carrier foil 1 rolled to 15 μm. After the NMP has been stripped off, a cathode film is obtained with a surface weight of 26.8 mg/cm².

The cathode active materials used have a degree a and b of lithiation of 0.8 in each case.

In a similar way, an anode coating material having a composition of 94 wt % natural graphite, 2 wt % SBR, 2 wt % CMC, and 2 wt % Super C65 is produced and applied to a 10 μm rolled copper carrier foil. The anode film thus produced has a surface weight of 12.2 mg/cm².

Prior to cell assembly, this anode film is prelithiated with 31 mAh lithium. Of this, about 11 mAh lithium constructs an SEI protective layer, and about 20 mAh lithium are intercalated into the graphite. As a result, the natural graphite has a composition of Li_{0.2}C₆, thus having a degree c. of lithiation of 0.2. 20 mAh lithium correspond to 0.75 mmol or 5.2 mg of lithium.

The cathode 2 with the cathode film is installed, using an anode 5 with the anode film, a separator 4 (25 μm), and an electrolyte 3 of a 1 M solution of LiPF₆ in EC/DMC (3:7 w/w), to form an electrochemical cell with an active electrode area of 25 cm², and this cell is packaged into composite aluminum foil (thickness: 0.12 mm) and sealed. The result is a pouch cell with external dimensions of about 0.4 mm×6.4 mm×4.3 mm.

After metering of the electrolyte and final sealing of the pouch cell, the lithium ion battery 10 produced in this way has an open voltage of around 3.1 to 3.5 V, resulting from the potential difference of the partially delithiated cathode 2 and of the prelithiated anode 5. The nominal capacity of the lithium ion battery 10 is 100 mAh, and so directly after production the lithium ion battery 10 has a state of charge (SoC) of 20%.

The cell is charged for the first time to 4.2 V (C/10) and subsequently discharged to 2.8 V at C/10. Because the cell after assembly and activation with liquid electrolyte already possesses an SoC of 20%, on further formation at C/10 a charge of 80 mAh is observed, whereas the first C/10 discharge is at 100 mAh.

The lithium ion battery 10 of the invention, accordingly, has an equally high capacity to that of the reference example.

### Comparison of the Examples

The use of the composite cathode active material comprising Li_{0.8}FePO₄ and Li_{0.8}Mn₂O₄ (example 2) in the cathode 2 of the lithium ion battery 10 reduces the cathode material usage relative to the reference example by about 10% (decrease in the surface weight of the cathode film from 29.8 mg/cm² in example 1 to 26.8 mg/cm² in example 2) for the same nominal capacity. This results from the prelithiation of the anode 5 and from the associated reduction in the irreversible capacity in the first charging cycle to 0. Additionally, the cell from example 2, because of the lower cathode loading, has an improved high-current capacity and a higher energy density. Furthermore, the cell conforming to example 2 does not require a complex and costly formation process any longer, and is therefore ready for use directly after the production step.

The lithium ion battery 10 of the invention is not limited to graphite as the anode active material; with advantage it is also possible to utilize silicon-based anode active materials or other anode active materials known in the prior art.

Although the invention has been illustrated and described in detail by reference to exemplary embodiments, the invention is not limited by the exemplary embodiments. It is the case, rather, that other variations of the invention may be derived therefrom by the skilled person, without departing from the scope of protection of the invention as defined by the claims.

### LIST OF REFERENCE NUMERALS

1 Current collector
2 Cathode
3 Electrolyte
4 Separator
5 Anode
6 Current collector
10 Lithium ion battery

1.-10. (canceled)

11. A lithium ion battery comprising:
a cathode comprising a composite cathode active material including a first cathode active material and a second cathode active material; and
an anode comprising an anode active material, wherein
the first and the second cathode active materials are each selected from the group consisting of: layered oxides, compounds with olivine structure, compounds with spinel structure, and combinations thereof,
the first cathode active material has a degree a of lithiation and the second cathode active material has a degree b of lithiation,
before a first discharging and/or charging of the lithium ion battery, a<1, b<1 and |a−b|<0.1, and
before the first discharging and/or charging of the lithium ion battery, the anode active material is prelithiated.

12. The lithium ion battery according to claim 11, wherein
0.5≤a≤0.9 and/or 0.5≤b≤0.9.

13. The lithium ion battery according to claim 11, wherein
the first cathode active material and the second cathode active material have a different crystal structure.

14. The lithium ion battery according to claim 13, wherein
the first cathode active material is a compound with spinel structure and the second cathode active material is a compound with olivine structure.

15. The lithium ion battery according to claim 11, wherein
particles of the second cathode active material have on average a smaller diameter than particles of the first cathode active material.

16. The lithium ion battery according to claim 15, wherein
the particles of the first cathode active material have on average a diameter d₁>1 μm and the particles of the second cathode active material have on average a diameter d₂≤1 μm.

17. The lithium ion battery according to claim 11, wherein
before the first discharging and/or charging of the lithium ion battery, the anode active material is prelithiated to an extent such that the lithium ion battery has a state of charge (SoC)>0 before the first discharging and/or charging.

18. A method for producing a lithium ion battery, the method comprising:
providing a composite cathode active material by mixing at least one first cathode active material and one second cathode active material, where the first and second cathode active materials are each selected from the group consisting: of layered oxides, compounds with olivine structure, compounds with spinel structure, and combinations thereof, where the first cathode active material has a degree a of lithiation and the second cathode active material has a degree b of lithiation, and where before a first discharging and/or charging of the lithium ion battery, a<1, b<1 and |a−b|<0.1;
providing an anode active material;
prelithiating the anode active material;
installing the composite cathode active material in a cathode and the anode active material in an anode; and
producing a lithium ion battery using the cathode and the anode, wherein
the anode active material is prelithiated before or after the installation of the anode active material in the anode.

19. The method according to claim 18, wherein
immediately after producing the lithium ion battery, and before a first discharging and/or charging thereof, the lithium ion battery has a state of charge (SoC)>0.

20. The method according to claim 18, further comprising:
before producing the lithium ion battery, forming a solid electrolyte interface (SEI) on the anode.

21. The method according to claim 20, wherein
forming the solid electrolyte interface (SEI) on the anode comprises electrochemically treating the anode active material, while installed to form an anode, in a lithium-containing electrolyte.

22. The method according to claim 20, wherein
forming the solid electrolyte interface (SEI) on the anode comprises storing the anode in an electrolyte.

23. The method according to claim 22, wherein
the anode is stored in the electrolyte for a predetermined period of 2 minutes to 14 days.

24. The method according to claim 18, wherein
the anode active material is prelithiated to an extent such that more lithium is present in the anode active material than needed for forming a solid electrolyte interface (SEI) on the anode.

25. The method according to claim 18, wherein
the anode active material is prelithiated before a first discharging and/or charging of the lithium ion battery.

26. The method according to claim 18, wherein
a degree c. of lithiation of the anode active material before a first discharging and/or charging of the lithium ion battery is more than 0.

27. The method according to claim 26, wherein
the degree c. of lithiation of the anode active material is in a range from 0.01 to 0.5.
